(19) United States
(12) Patent Application Publication
(10) Pub. No.: US 2016/0004995 A1
(43) Pub. Date: Jan. 7, 2016

(54) Retail Display Recognition System and Method of Use

(71) Applicants: Mickey Meehan, Walnut Creek, CA (US); Anton Vishnyak, San Ramon, CA (US); Kausain Ahmed, Walnut Creek, CA (US)

(72) Inventors: Mickey Meehan, Walnut Creek, CA (US); Anton Vishnyak, San Ramon, CA (US); Kausain Ahmed, Walnut Creek, CA (US)

(73) Assignee: MOBITOR CORPORATION, Walnut Creek, CA (US)

(21) Appl. No.: 14/856,799

(22) Filed: Sep. 17, 2015

Related U.S. Application Data
(60) Provisional application No. 62/175,980, filed on Jun. 15, 2015.

(51) Int. Cl. G06Q 10/08; H04W 4/00

(52) U.S. Cl. CPC G06Q 10/087; H04W 4/008

(57) ABSTRACT

Disclosed is a system and method for recognizing retail displays or fixtures. The system includes a plurality of beacons that is in communication with one or more user devices operated by an end user, wherein the beacons are attached to retail displays. Each of the plurality of beacons includes a set of unique identifier stored therein so as to identify a retail display on which it is attached. The user device is configured to locate a beacon and determine whether or not the unique identifier of the beacon matches the unique identifier for the beacon stored in the system.

### CROSS-REFERENCE TO RELATED APPLICATIONS

This application claims the benefit of U.S. Provisional Patent Application No. 62/175,980, filed Jun. 15, 2015, which is hereby incorporated by reference in its entirety.

### FIELD OF THE INVENTION

The present invention generally relates to a new and improved retail display recognition system and method of use thereof. More particularly, the present invention is directed to a system and method for auditing correct retail displays and fixtures with beacons.

### BACKGROUND OF THE INVENTION

Many stores carry numerous merchandise and products for various brands. Thus, many companies require store sales representatives and merchandisers to conduct merchandise auditing and survey retail displays or fixtures to ensure that specific goods and items are accurately and uniformly displayed in various stores. Currently, the methods of merchandise auditing and surveying retail displays or fixtures are limited to visiting stores on a regular basis, visually inspecting the retail displays or fixtures to be audited, and recording the audit manually.

However, this method is problematic and ineffective when the sales representatives and merchandisers are unfamiliar with the retail displays or fixtures. Even when the sales representatives and merchandisers are familiar with the retail displays or fixtures in question, the existing system and method do not allow the sales representatives and merchandisers to make sure that they are collecting data against or auditing the correct retail fixture. In this regard, there is a need in the prior art for a system and method that allow sales representatives and merchandisers to collect information against the correct retail displays or fixtures.

Some systems in the prior art utilize short-range signal emitting devices to communicate with individuals in a store setting. While these signal emitting devices generally communicate with the individuals via a computer system, these computer systems do not comprise handheld electronic devices that are operable via an end user, wherein the handheld electronic devices are configured to verify whether a correct retail display or fixture is audited.

Other systems in the prior art comprise short-range signal emitting devices that communicate with handheld electronic devices that are operable via the end user. These systems, however, are configured to locate individuals such as shoppers via detecting signals emitted from the handheld electronic devices in order to broadcast commercial messages. In this regard, the handheld electronic devices do not scan or seek the beacons in order to audit retail fixtures.

Finally, some prior art references disclose the method of assigning identifiers to signal-emitting devices such as beacons to inventory items. In this regard, these prior art references do not disclose beacons that comprises a set of unique identification numbers stored therein.

### SUMMARY OF THE INVENTION

In view of the disadvantages inherent in the known types of devices and systems for auditing retail merchandise now present in the prior art, the present invention provides an improved a system for recognizing retail displays or fixtures and method of use.

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as to prelude to the more detailed description that is disclosed later.

In a preferred embodiment, the present invention comprises a system for recognizing retail displays or fixtures and method of use. In one embodiment, the system comprises a plurality of beacons, each of the beacons removably attached to a retail display or fixture. Each beacon further comprises a set of identification numbers, which include a beacon identification number, a store identification number, and an item identification number. In other embodiments, the store identification number further comprises a department identification number, an aisle identification number, and/or a bin identification number. In this regard, each beacon associates a particular retail display or fixture with a particular store and/or location.

The beacon is in wireless communication with one or more user devices and can transmit the identification numbers stored therein. An end user can use the user device to scan for the beacons and to verify whether the user is within a predetermined proximity of a specific store display or fixture. In this way, the present system and method allows users to confirm that they are collecting data against or auditing the correct retail display or fixture.

It is therefore an objective of the present invention to provide a system that allows end users to accurately audit retail displays whether or not the end users are familiar with a particular retail display that they are auditing.

It is another objective of the present invention to provide a system that utilizes beacons for associating a particular retail display or fixture with a particular store and/or location.

It is still another objective of the present invention to provide a system that comprises a client side application for matching a beacon with a unique identifier that is associated with a retail display.

It is still another objective of the present invention to provide a system that utilizes standard SDK, application program interface (API), and programming conventions to allow for access to any number of features and functions.

It is still another objective of the present invention to provide a server that can manage unique identifiers that are associated with respective beacons and retail displays.

It is still another objective of the present invention to provide a system that allows end users to accurately audit retail displays for an unlimited number of retailers and vendors in various store settings.

In the light of the foregoing, these and other objective are accomplished in accordance of the principles of the present invention, wherein the novelty of the present invention will become apparent from the following detailed description and appended claims.

### BRIEF DESCRIPTION OF THE DRAWINGS

The above and other objects and advantages of the present invention will be apparent upon consideration of the following detailed description, taken in conjunction with the accompanying exemplary drawings, in which like reference characters refer to like parts throughout, and in which:

FIG. 1 is a high-level schematic diagram of the present system.

FIG. 2 is an exemplary block diagram of the present system.

FIG. 3 is a block diagram of an exemplary computer system of the present invention.

FIG. 4 shows an exemplary work flowchart of the present method.

### DETAILED DESCRIPTION OF THE INVENTION

The present invention is directed towards a system and method for recognizing retail displays or fixtures. For purposes of clarity, and not by way of limitation, illustrative views of the present invention are described with references made to the above-identified figures. Various modifications obvious to one skilled in the art are deemed to be within the spirit and scope of the present invention.

As used in this application, the terms “component,” “module,” “system,” “interface,” or the like are generally intended to refer to a computer-related entity, either hardware or a combination of hardware and software. For example, a component can be, but is not limited to being, a process running on a processor, an object, and/or a computer. By way of illustration, both an application running on a controller and the controller can be a component. One or more components can reside within a process and/or thread of execution and a component can be localized on one computer and/or distributed between two or more computers.

As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, or media.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or.” Additionally, the articles “a” and “an” as used in this application and the appended claims should generally be construed to mean “one or more” and “at least one” unless specified otherwise or clear from context to be directed to a singular form. It is to be appreciated that determinations or inferences referenced throughout the subject specification can be practiced through the use of artificial intelligence techniques.

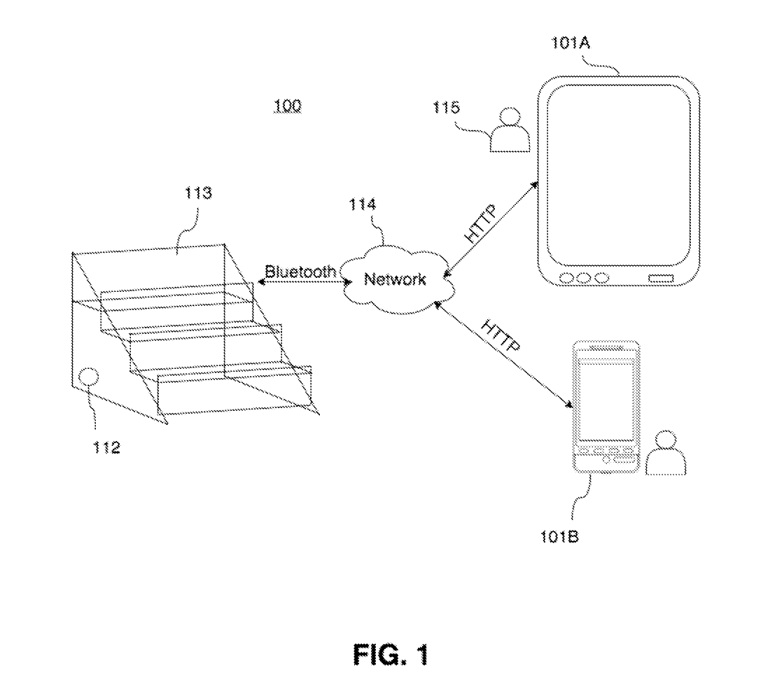

Referring now to FIG. 1, there is shown a view of the present system 100. The present invention comprises a plurality of user devices 101A, 101B in communication with one or more beacons 112 on a retail display 113 over a network 114, wherein the user devices 101A, 101B are operated via an end user 115, further wherein the end user 115 is the person performing a retail display audit. Without limitation, the user devices 101A, 101B comprise a portable user device such as a tablet computer, a mobile device, a personal digital assistant (PDA), an e-reader, or other data-enabled device. Additionally, the network 114 comprises the Internet, a local area network (LAN), a wide area network (WAN), wireless data networks such as Wifi, and the like.

Non-limiting examples of a retail display 113 includes, displays of items on shelves at selected stores, including grocery stores, wholesale stores, museums, special promotional displays of goods, manufacturer supplied displays of goods, and/or any other arrangement and display of items separate from the store shelving providing the customary/usual display of a store's inventory. Additionally, the retail display 113 may comprise a freestanding display stand as depicted in FIG. 1, or displays on shelves in an aisle of a grocery or other retail store.

The beacon 112 of the present system comprises any variety of beacons comprising a transmitter and a plurality of identifiers stored therein. The beacon 112 is removably attached to the retail display 113 or is structurally integral thereto. The specific type of the beacon 112, however, is not of primary relevance with regard to the intent of the present invention, which portends to provide a retail display auditing system that utilizes beacons to associate a particular retail display or fixture with a particular store and/or location.

Each of the beacons 112 and the retail display 113 is linked to a client account, which is created by a client that controls the retail display 113 and that provides or supplies all and any goods displayed thereon. It is contemplated that the client may comprise an individual person or an entity, depending upon embodiment. It is important to distinguish that the client is not the actual store, the retailer, or the vendor offering the goods for sale displayed on the retail display 113.

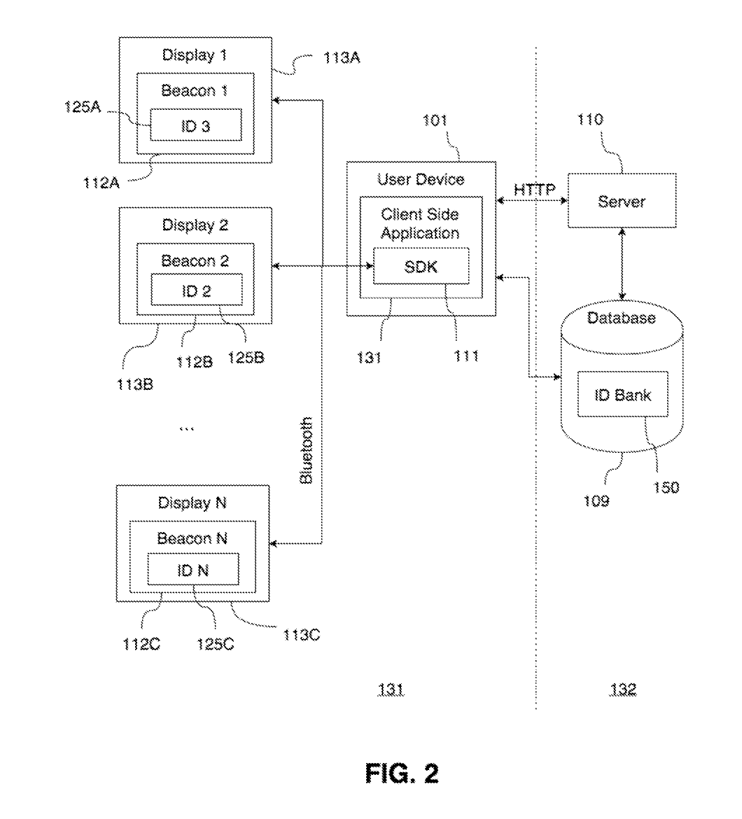

Referring now to FIG. 2, there is shown an exemplary block diagram of the present system. The front end 131 of the system comprises a user device 101 in communication with a plurality of beacons 112A-112C, wherein each of the beacons 112A-112C is attached to a retail display 113A-113C or items in a store. Each of the beacons 112A-112C comprises a unique identifier set 125A-125C. In a preferred embodiment, the identifier set 125A-125C comprises a beacon identification number for identifying itself, as well as a store identification number for identifying its location, and a display identification number for identifying a retail display to which it is associated. Because each of the identification number set 125A-125C is unique, each retail display comprises different identification numbers.

The user device 101 is configured to detect the beacons 112A-112C that are within proximity thereof or when the beacons 112A-112C are within a predetermined distance from the user device 101, e.g., via geofencing. Once a beacon 112A-112C is detected, the beacon 112A-112C transmits its unique identifier set 125A-125C. The identifier set 125A-125C may be transmitted using any suitable transfer protocols such as short range wireless communication protocols, e.g., Bluetooth. The user device 101 can determine the identifier set of the beacon via a client side application 131 installed thereon, which comprises a SDK 111. In this regard, the client side application 131 comprises a mobile application that is native to the user device 101. In other embodiments, however, it is contemplated that the client side application 131 comprises a web application, a website, and the like.

In another embodiment, the user device 101 is configured to locate a specific beacon 112A-112C by its identification number. In this regard, it is contemplated that the client side application 131 comprises a graphic user interface (GUI) for manually entering a known beacon identification number. In yet another embodiment, the user device 101 is configured to locate a specific beacon 112A-112C by its geographic location. In this regard, it is contemplated that the client side application 131 comprises a mapping feature that utilizes a global positioning system (GPS) module and that allows a user to view a graphic representation of the beacons 112A-112C on a map in a given location or within a specific area such as a store.

The back end 132 of the system comprises a server 110 in communication with a database 109. The database 109 comprises an identification bank 150, which includes a plurality of identifier sets therein. In this way, the database 109 includes unique identifier set 125A-125C for each of the retail displays 113A-113C or items registered in the system.

It is contemplated that the identification bank 150 is managed via the server 110 such that the identifier sets in the identification bank can be updated or deleted and new identifier sets can be added to the identification bank 150. In this way, the server 110 is programmed to manage the identification numbers 125A-125C for each of the beacons 112A-112C, stores, and retail displays 113A-113C or fixtures. Additionally, the server 110 may be programmed to manage information regarding specific retail display 113A-113C, fixtures and/or goods displayed thereon. Non-limiting examples of these information include pricing, model number, images, back log information, and the like.

The user device 101 communicates with the database 109 and the server 110 e.g., using a secure HTTP or other data communications protocol. Upon receiving the identifier set 125A-125C from the beacon 112A-112C, the client side application 131 is programmed to transmit a request to the server 110 to locate and retrieve an identifier set from the identification bank 150 that corresponds to the beacon identification number associated the beacon 112A-112C.

Once the retrieved identifier set from the identification bank 150 is transmitted to the user device 101, the client side application 131 determines whether the two identifier sets match. If the two identifier sets match, then the client side application 131 informs the end user that the user is auditing the correct retail display 113A-113C or fixture. If the two identifier sets do not match, then the client side application 131 informs the end user that the user is not auditing the correct retail display 113A-113C or fixture.

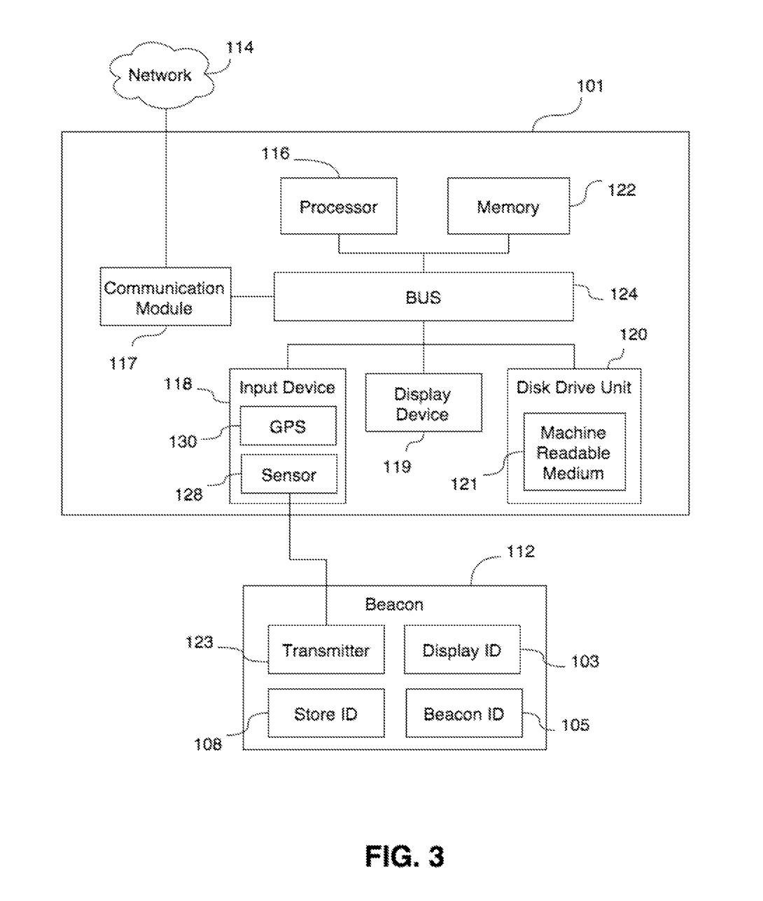

Referring now to FIG. 3, there is shown a block diagram of an exemplary computer system of the present invention. The exemplary user device 101 comprises a processor 116, e.g., a central processing unit (CPU), a graphic processing unit (GPU), a memory unit 122, e.g., a main memory, a static memory, which communicate with each other via a bus 124. The memory unit 122 may comprise the client side application that is native to the user device 101.

The user device 101 further comprises a communication module 117, at least one input device 118, a display device 119, and a disk drive unit 120. The input device 118 comprises a user input device such as a keyboard, a mouse, a microphone, and an environment input device such as a sensor 128 and a GPS module 130.

The sensor 128 is adapted to detect the presence of a beacon 112 that is within proximity of the user device 101 or when the beacon 112 is within a predetermined distance from the user device 101. It is contemplated that the beacon 112 is configured to emit a signal via a wireless transmitter 123 so that it is detectable via the sensor 128. When the sensor 128 picks up the beacon signal, it triggers the processor 116 of the user device 101 to determine whether or not the beacon 112 is a registered beacon 112 in the system.

The transmitter 123 is further configured to emit the unique identifier set stored in the beacon 112, wherein the unique identifier set includes a beacon identification number 105, a store identification number 108, and a display identification number 103. Without limitation, the store identification number may further comprise a department identification number, an aisle identification number, and/or a bin identification number. In some embodiments, the beacon identification number 105, the store identification number 108, and the display identification number 103 can be updated or deleted so that a net set of unique identifier can be stored in the beacon 112 and the beacon 112 can be used for other retail displays in different stores.

The disk drive unit 120 comprises a machine-readable medium 121 on which is stored one or more sets of data structures and instructions embodying or utilized by any one or more of the methodologies or functions described herein. The instructions may also reside, completely or at least partially, within the memory unit 122 and/or within the processor 116 during the execution thereof by the user device 101, the memory unit 122 and the processor 116 also constituting machine-readable media.

The instructions may further be transmitted or received over the network 114 using a transmission medium, such as a signal on a communications link. The instructions may also be transmitted using any suitable transfer protocols, such as HTTP as described above.

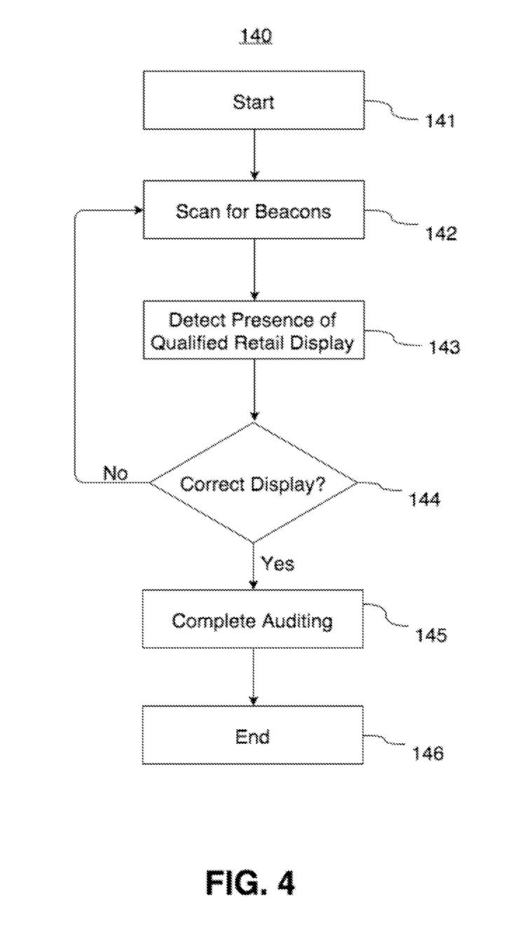

Referring now to FIG. 4, there is shown an exemplary workflow chart of the present method 140. To start 141, the user device scans for beacons 142 that are within a predetermined distance from the user device via the sensor that is embedded therein. The user may automatically scan for beacons 142 that are within the proximity of the user device or manually look for specific beacons 142 by entering a beacon identification number or using a mapping feature and viewing the beacons on a map displayed on a GUI of a client side application.

Upon receiving a beacon signal from one or more beacons, the user device can detect presence of a qualified retail display 143. To determine whether the user is auditing a correct retail display, the user device retrieves a unique identifier set from the beacon and requests the server to retrieve another identifier set from the database that corresponds to the beacon. More particularly, the server uses the beacon identification number contained in the unique identifier set of the beacon to retrieve a second identifier set containing the same beacon identification number from the identification bank of the database.

Upon retrieving the second identifier set from the database, the server relays the second identifier set to the user device so that the client side application determine whether all of the identification numbers contained in the two identifier sets match. If the identifier set of the beacon and the second identifier set from the identification bank of the database match, the client side application can notify the user that he or she is audition the correct retail display 144.

If the correct retail display or fixture has been located 144, the user can resume auditing the retail display or fixture 145 and end 146 the process. If the correct retail display or fixture has not been located, the user can continue scanning for other beacons within the store 142.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A system for auditing retail displays, comprising:
a beacon comprising a transmitter for transmitting beacon signals and an identifier set stored therein, wherein said beacon is attached to a retail display;
a user device and a server in communication over a network;
said server and said user device having access to a database;
said user device having a client side application for communication with said server and a sensor for detecting said beacon signals, wherein upon detecting said beacon signals, receiving said identifier set from said beacon and transmitting said identifier set to said server to request said server to retrieve a second identifier set from said database, further wherein upon receiving said second identifier set from said server, determining whether said identifier set and said second identifier set match.

2. The system of claim 1, wherein said database comprises an identification bank;
said identification bank comprising said second identifier set.

3. The system of claim 2, wherein said server is further configured to manage said identification bank of said database.

4. The system of claim 1, wherein each of said identifier set and said second identifier set comprises a beacon identification number, a store identification number, and a display identification number.

5. The system of claim 4, wherein said server retrieves said second identifier set comprising said beacon identification number of said identifier set such that said beacon identification number of said identifier set and said beacon identification number of said second identifier set are identical.

6. The system of claim 1, wherein said user device further comprises a GPS module to determine a location of said user device with respect to a location of said beacon.

7. A computer-implemented method for auditing retail displays, comprising executing on a processor the steps of:
scanning for a beacon with a user device to establish a communication with said beacon to detect a retail display and to retrieve an identifier set stored in said beacon, said identifier set associated with a retail display on which said beacon is attached;
upon receiving said identifier set from said beacon, transmitting to a server said identifier set to request said server to retrieve a second identifier set from a database, wherein each of said identifier set and said second identifier set comprises a beacon identification number, further wherein said beacon identification number of said identifier set and said beacon identification number of said second identifier set are identical;
comparing said identifier set and said second identifier set to determine whether said identifier set and said second identifier set are identical;
if said identifier set and said second identifier set are identical, verifying said retail display is a correct display.

8. The method of claim 7, wherein each of said identifier set and said second identifier set further comprises a store identification number and a display identification number.

9. The method of claim 7, further comprising the steps of determining a distance between said user device and said beacon.

10. The method of claim 7, wherein scanning for said beacon further comprises the steps of:
automatically receiving beacon signals from said beacon, wherein said beacon is within proximity of said user device.

11. The method of claim 7, wherein scanning for said beacon further comprises the steps of:
using a mapping feature to view said beacon on a map displayed on a GUI of a client side application on said user device.

12. A computer-readable storage medium comprising instructions, comprising:
instructions for detecting a beacon attached to a retail display, said beacon comprising an identifier set, wherein said identifier set identifies said beacon and said retail display;
instructions for transmitting, upon detecting said beacon, said identifier set to a server to retrieve a second identifier set from a database;
instructions for comparing, upon receiving said second identifier set from said server, said second identifier set and said identifier set in order to determine whether said second identifier set and said identifier set match.

13. The computer-readable storage medium of claim 12, wherein each of said identifier set and said second identifier set comprises a beacon identification number, a store identification number, and a display identification number, further wherein said beacon identification number of said identifier set and said beacon identification number of said second identifier are identical.

14. The computer-readable storage medium of claim 12, further comprising instructions for mapping said beacon and displaying said beacon on a mapping feature on said user device.

15. The computer-readable storage medium of claim 12, further comprising instructions for verifying that said retail display is a correct display if said identifier set and said second identifier set are identical.
